(19) United States
(12) Patent Application Publication
(10) Pub. No.: US 2013/0339102 A1
(43) Pub. Date: Dec. 19, 2013

(54) PROPOSAL EVALUATION SYSTEM

(71) Applicant: The One Page Company Inc., San Francisco, CA (US)

(72) Inventors: Patrick G. Riley, San Francisco, CA (US); Joanna R. Weidenmiller, San Francisco, CA (US); Stefan Proud, Sacramento, CA (US); John S. Bronson, San Francisco, CA (US); Stephane Come, Sacramento, CA (US)

(73) Assignee: The One Page Company Inc., San Francisco, CA (US)

(21) Appl. No.: 13/915,763

(22) Filed: Jun. 12, 2013

Related U.S. Application Data
(60) Provisional application No. 61/659,729, filed on Jun. 14, 2012.

(51) Int. Cl. G06Q 10/06

(52) U.S. Cl. CPC G06Q 10/0637
USPC 705/7.36

(57) ABSTRACT

Described herein are techniques and mechanisms for evaluating proposal documents. According to various embodiments, a proposal document may represent a proposal for business action. The proposal document may be processed via a processor to determine a plurality of scores for the proposal document. Each of the plurality of scores may evaluate the proposal document in accordance with a respective one or more criteria. The plurality of proposal scores may be aggregated via the processor to create a composite score for the proposal document. The composite score may represent a measure of quality associated with the proposal document. The composite score may be stored on a storage medium.

### CROSS-REFERENCE TO RELATED APPLICATIONS

This application claims priority under 35 U.S.C §120 to Provisional U.S. Patent App. No. 61/659,729 (Atty. Docket No. ONEPP005P) by Riley et al., titled “Proposal Evaluation System”, filed Jun. 14, 2012, which is hereby incorporated by reference in its entirety and for all purposes.

### TECHNICAL FIELD

The present disclosure relates to the field of personal and business planning and development, and more specifically to techniques and mechanisms for preparing and evaluating various types of proposals for action.

### DESCRIPTION OF RELATED ART

Business plans and other types of project proposals are vital communication tools in the business world. Companies and individuals must be able to plan potential projects and subsequently communicate these plans in a clear and coherent manner to potential investors and partners. This is often done in the form of a written document outlining and detailing the key elements of the project.

Although clear communication is important, time is also often critical in making business decisions. A proposal or plan may be comprehensive, but too cumbersome and lengthy to read thoroughly. A person may not have time to digest all of the material. Key information can become lost in verbiage and overlooked. As a result, a proposal may be rejected not for failing to be a viable idea, but because it was not communicated efficiently enough.

The process of evaluating business documents such as resumes, business plans, requests for proposals (RFP)s, or proposals is often time-consuming, subjective, and inefficient. Different human reviewers may evaluate the same document quite differently. Machine evaluation is often ineffective. When interviews are conducted, interviewers are often poorly trained and fail to coordinate with each other. Thus, the evaluation of candidates, proposals, or business propositions is often ad hoc and improved, resulting in suboptimal business choices.

### SUMMARY

Described herein are methods, systems, devices, and computer readable media for evaluating proposal documents. According to various embodiments, a proposal document may represent a proposal for business action. The proposal document may be processed to determine a plurality of scores for the proposal document. Each of the plurality of scores may evaluate the proposal document in accordance with a respective one or more criteria. The plurality of proposal scores may be aggregated via the processor to create a composite score for the proposal document. The composite score may represent a measure of quality associated with the proposal document. The composite score may be stored on a storage medium.

According to various embodiments, the proposal document may be associated with a request for proposals document describing a business need, and the one or more criteria measure a responsiveness of the proposal document to the business need described in the request for proposals document. The proposal document may be arranged on a single page. According to various embodiments, the plurality of scores may include a first score determined by analyzing the proposal for the presence of one or more keywords via a processor, a second score determined based on first user input representing evaluation of the proposal by a human, and a third score determined based on second user input representing an interview conducted in association with the proposal.

According to various embodiments, the plurality of proposal scores may include a keyword-based proposal score determined by analyzing the proposal document for the presence of one or more keywords. Determining the keyword-based proposal score may include identifying a match for a designated one of the one or more keywords, determining a context associated with the identified match, and determining a keyword match score value based on the determined context. The one or more criteria may include an indication of the one or more keywords.

According to various embodiments, the plurality of proposal scores may include a human-based proposal score determined by analyzing user input representing evaluation of the proposal document by a human. Determining the human-based proposal score may include identifying a plurality of sections of the proposal document for analysis. The one or more criteria may designate the plurality of sections. The user input may include a respective proposal score value for each of the identified plurality of sections.

According to various embodiments, the plurality of proposal scores may include an interview-based proposal score determined by analyzing user input representing an interview of an individual in association with the proposal document. Determining the interview-based proposal score may include identifying a plurality of interview factors for evaluation. The user input may include a respective proposal score for each of the identified interview factors.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a method for evaluating a proposal in accordance with techniques and mechanisms described herein.

FIGS. 2 and 3 illustrate examples of a system that may be used in accordance with techniques and mechanisms described herein.

FIG. 4 illustrates one example of a method for evaluating a proposal based on machine evaluation techniques in accordance with techniques and mechanisms described herein.

FIG. 5 illustrates one example of a method for evaluating a proposal based on human evaluation techniques in accordance with techniques and mechanisms described herein.

FIG. 6 illustrates one example of a method for evaluating a proposal based on interview evaluation techniques in accordance with techniques and mechanisms described herein.

FIGS. 7-10 illustrate examples of a system that may be used in accordance with techniques and mechanisms described herein.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, some of the techniques of the present invention will be described in the context of proposal documents, such as proposal documents related to employment opportunities. However, it should be noted that the techniques of the present invention apply to a wide variety of different documents and communications. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Techniques and mechanisms described herein facilitate the creation and publishing of requests for proposals (RFPs) by users acting as individuals or representing organizations. The RFPs may then be published and viewed by or transmitted to interested recipients. The recipients may then create proposals in response to the RFPs. A proposal system for facilitating the creation of RFPs and proposals generated in response to RFPs may facilitate various types of business transactions.

According to various embodiments, a proposal system may provide a platform for companies to publish RFPs for open positions or projects to be filled. The proposal system may provide a platform for job seekers to create and submit proposals or ideas in response to open RFPs. The proposal system may facilitate the gathering of statistics and analytics, such as information related to employment or company performance. The proposal system may facilitate the development of new techniques for matching business partners with each other, employees with employers, and problems with solutions.

### Example Embodiments

Described herein are techniques and mechanisms for evaluating business documents such as proposals. In many instances, a business may receive hundreds or thousands of document submissions such as resumes or proposals for filling an employment opportunity. Techniques described herein facilitate the sorting of proposals to allow the selection of a single proposal or a limited number of proposals for adoption.

According to various embodiments, techniques and mechanisms described herein may promote the aggregation of various types of scores of proposals. For instance, scores determined by machine evaluation, human evaluation, and interview evaluation may be combined to create an aggregate score for a proposal. Within each of these types of evaluation, the scores may be determined by an aggregation of sub-scores that are objectively determined based on designated evaluation criteria or factors. In particular embodiments, by aggregating scores in this way, the evaluation process may be made faster, more objective, and more accurate.

According to various embodiments, each proposal may be evaluated to determine whether to adopt the proposal. Proposals may be compared with each other so that only the highest ranked proposals are selected for adoption. Each proposal may be evaluated to determine a score or other metric. The score or metric may indicate a quality or value of the proposal as compared to other proposals. Additionally, or alternately, the score or metric may indicate a match between the proposal and a company or RFP in response to which the proposal was submitted.

According to various embodiments, techniques described herein may promote standardization of the review process. In a machine-evaluation process, each proposal may be compared against preexisting proposals known to have been effective. In a human-evaluation process, each proposal may be evaluated by each reviewer according to the same set of criteria. In an interview process, each candidate may be interviewed in a similar way even if the interviewer differs between candidates. When these review processes are standardized, the different interview scores may be more readily compared and aggregated, leading to a less subjective and more precise proposal reviewing process.

According to various embodiments, techniques and mechanisms described herein may apply widely to the evaluation of various types of business documents. The types of business documents may include, but are not limited to: proposals for action, requests for proposals, resumes, business plans, general contracts, advertisements, service agreements, procurement contracts, consulting arrangements, and agreements for legal representation.

According to various embodiments, authoring and submitting a proposal for employment may offer various advantages to job applicants in comparison with sending a traditional resume. For example, a proposal may allow a job applicant to present a compelling case for a company to hire the applicant. The proposal may be used to show the prospective employer exactly how the applicant will make the company better and more successful. By presenting the applicant in a way that an ordinary resume can't accomplish, a proposal may significantly increase the applicant's chances of landing a job. Creating a proposal may also help give the applicant helpful insights into the applicant's unique personal qualities and life experiences, which may help the applicant better stand out as a job candidate.

According to various embodiments, authoring an RFP and receiving proposals for employment may offer various advantages to organizations in comparison with traditional postings on job boards or other mechanisms and techniques to alerting prospective job applicants to employment opportunities. Traditional recruitment typically involves resumes. While resumes often provide information regarding personal data and a candidate's experience and knowledge, resumes typically provide little detail regarding the candidate's mindset and attitude. In contrast to resumes, proposals created in accordance with the techniques described herein may be used to evaluate a candidate's abilities in comprehension, analysis, synthesis, and evaluation. In order to solicit proposals, a company may create a request for proposals that describe the challenges and needs facing the organization. Then, the company will receive a proposal from each job applicant that describes exactly how that job applicant plans to solve the challenges and fulfill the needs described in the RFP.

According to various embodiments, a proposal may include designated content sections, which may appear in a designated order. For example, a proposal may include Title and/or Subtitle sections that define the proposal, Target and/or Secondary Target sections that identify the goals of the proposal, a Rationale section that lays out the basic reasons why the action is necessary, a Financial section that describes the financial aspects of the deal, a Status section that describes a current state of affairs, and/or an Action section that indicates exactly what the proposer wants the recipient to do.

In some cases, the discussion of embodiments herein refers to proposals and RFPs authored and processed for the purposes of connecting job applicants with potential employers. However, according to various embodiments, the techniques and mechanisms discussed herein may be used to facilitate a wide variety of business transactions and relationships. These transactions and relationships may include, but are not limited to, employment opportunities, procurement contracts, service agreements, consulting arrangements, and legal representation.

According to various embodiments, a proposal and/or an RFP may be created in accordance with a designated format. In particular embodiments, the format may limit both each proposal and each RFP to a single page. Accordingly, some embodiments discussed herein and illustrated in the drawings may refer to a one page proposal. However, various types of formats and restrictions on proposals and RFPs may be used. For example, proposals and/or RFPs may be limited to a different length. As another example, proposals and/or RFPs may be created in accordance with restrictions on the type and order of content included in each document. As yet another example, in some embodiments formatting characteristics such as content or length may serve as guidelines rather than strict limits. In some embodiments, the types of formats and restrictions used may be strategically determined based on factors such as the type of information conveyed by the communications and the type of industry in which the communications are conducted.

According to various embodiments, the infrastructure for providing a proposal system may be configured in various ways. In particular embodiments, the infrastructure may be provided via a cloud computing framework. In a cloud computing framework, hardware and basic software such as web server software may be provided in a scalable, on-demand fashion by a third-party, while the service provider of the proposal system provides the application logic and other high-level functionality for generating the proposal system. Alternately, the infrastructure may be provided via a more conventional computing framework, for example a computing framework in which the hardware and/or basic software for providing access to the system is controlled by the service provider of the proposal system.

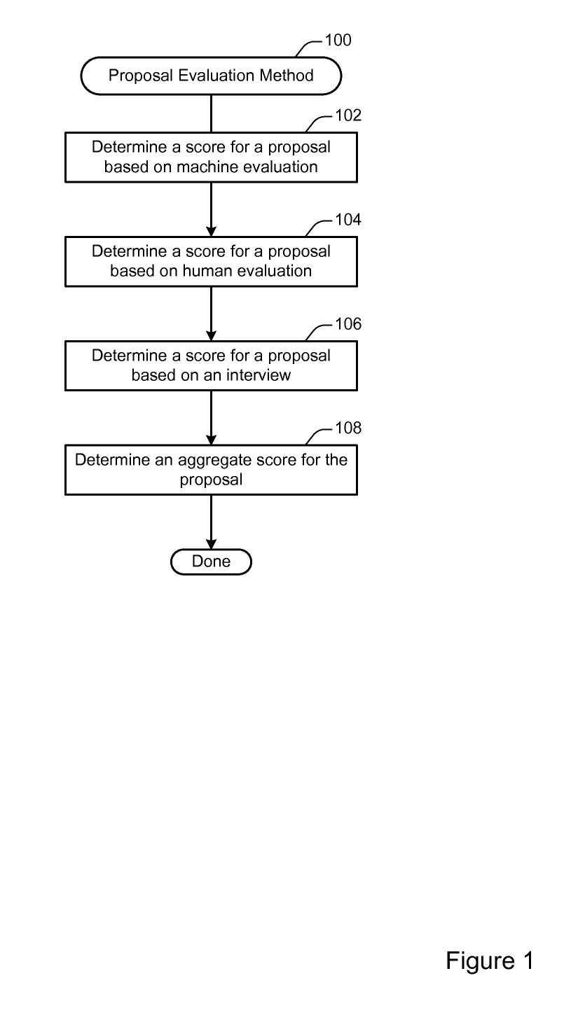

FIG. 1 illustrates one example of a method 100 for evaluating a proposal in accordance with techniques and mechanisms described herein. According to various embodiments, the method 100 may be used to provide a standardized process for evaluating a proposal based on various metrics. Scores based on machine-based evaluation, human-based evaluation, and interview-based evaluation may be determined in a standardized, objective way. Then, these scores may be combined to create an aggregate score for evaluating the proposal.

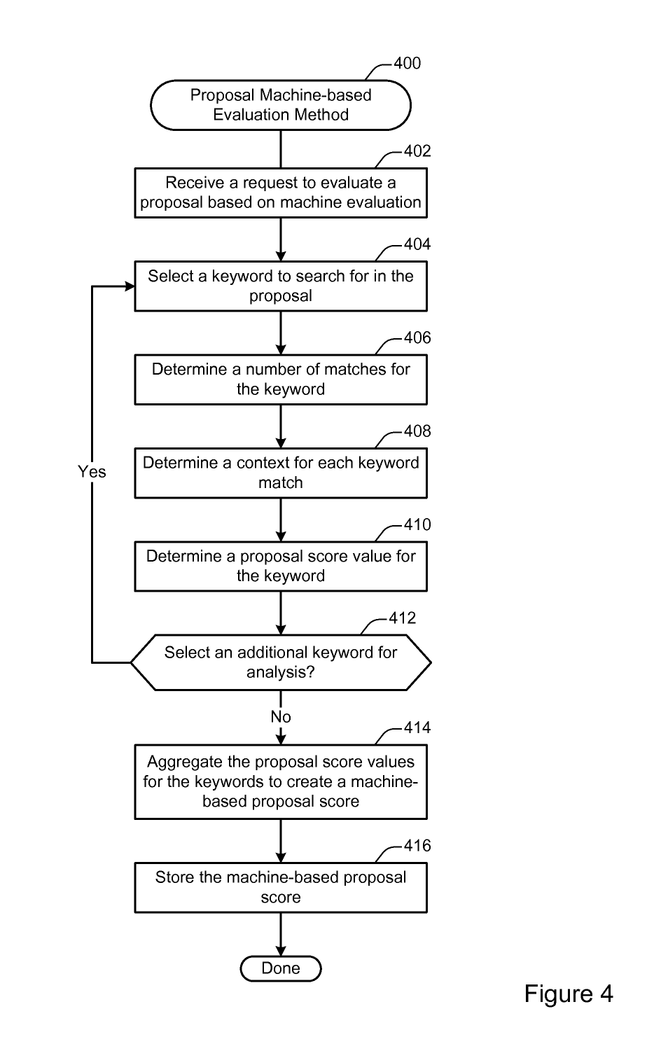

At 102, a score for a proposal based on machine evaluation is determined. In particular embodiments, a computer program may search a proposal for keywords that are deemed important, for instance for a particular proposal or RFP. Then, the program may determine a context for each of the keywords, since some keywords may be more significant when used in a particular fashion. Next, the program may determine a machine-based score for the proposal based on the presence and use of the keywords. Techniques for determining a machine-based proposal score are discussed in further detail with respect to FIG. 4.

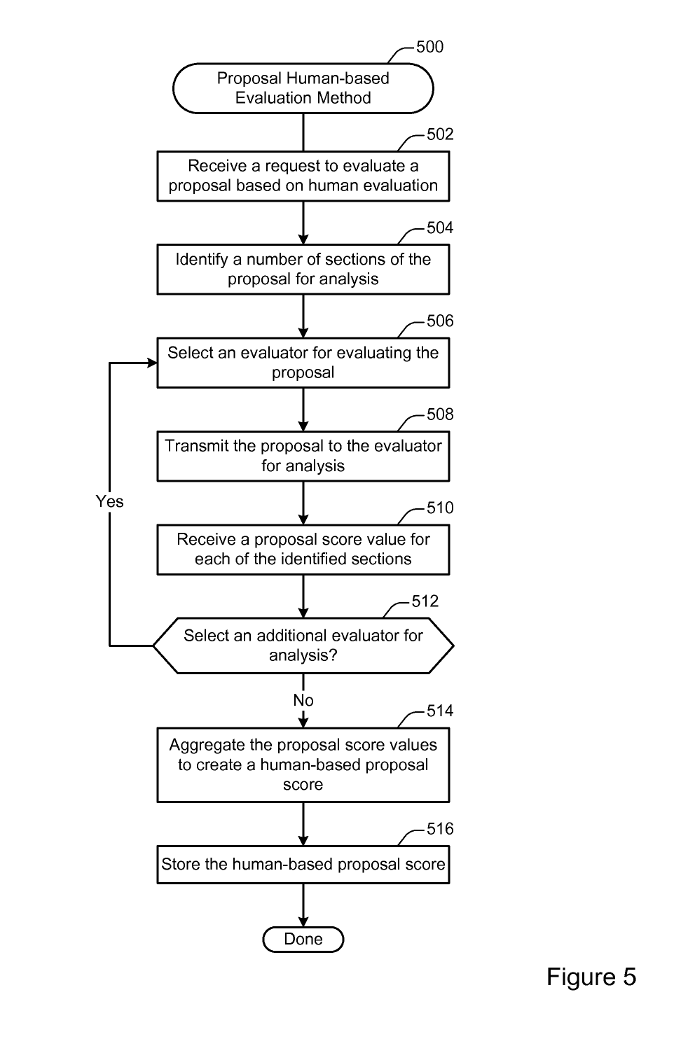

At 104, a score for a proposal based on human evaluation is determined. According to various embodiments, a standardized process for evaluating a proposal may be applied by a number of human evaluators. Then, the values produced by the human evaluators may be aggregated to create an aggregate human-based proposal score. Because a proposal can be evaluated by several human evaluators according to a standardized process, the evaluation process can be made more objective and powerful than an ad hoc process while retaining the advantages of human-based evaluation of a proposal. Techniques for determining a human-based proposal score are discussed in further detail with respect to FIG. 5.

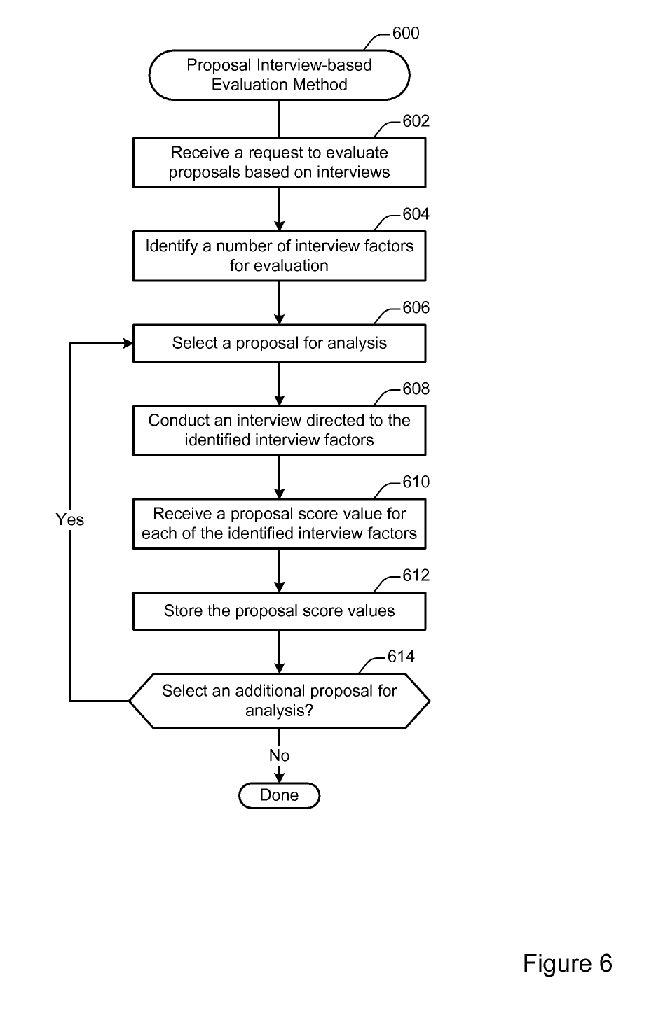

At 106, a score for a proposal based on an interview is determined. According to various embodiments, a standardized interview process may be applied to a group of proposals. Then, the author each of the proposals may be interviewed with the standardized process, which may produce a standardized interview-based proposal score. In this way, the interview process may be made more objective and useful than an ad hoc process while retaining the advantages of an interview-based evaluation. Techniques for determining an interview-based proposal score are discussed in further detail with respect to FIG. 6.

At 108, an aggregate score for the proposal is determined In particular embodiments, the aggregate score may be determined by combining the machine-based, human-based, and interview-based scores. The aggregate score may be stored in a database, transmitted to a user such as a hiring manager, or otherwise processed.

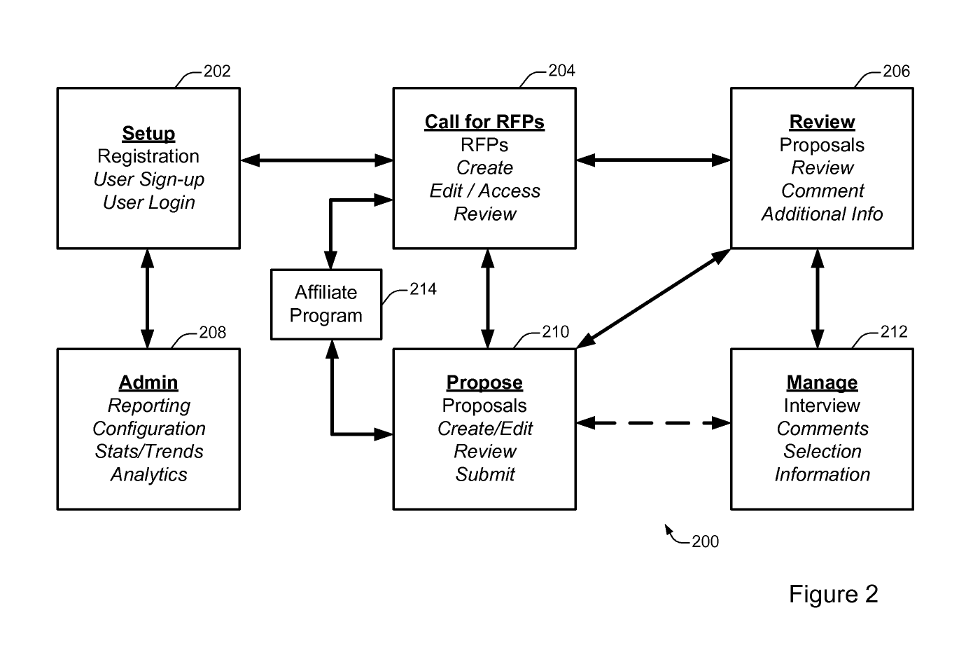

FIG. 2 shows a system 200 that may be used in accordance with techniques and mechanisms described herein. According to various embodiments, the system 200 may be used to generate, respond to, evaluate, transmit, receive, and administer proposals and requests for proposals (RFPs). The system 200 includes various modules for performing operations related to proposal generation and processing. These modules may be implemented on various computing devices in communication via a network. In particular embodiments, some modules may be implemented on the same computing device. Alternately, a module may be spread across more than one computing device.

The system 200 includes a setup module 202, an administration module 208, an RFP generation module 204, an RFP review module 206, a proposal generation module 210, a management module 212, and an affiliate program module 214. In some embodiments, a proposal system may include operations not shown in FIG. 2. Alternately, a proposal system may not include one or more of the modules shown in FIG. 2.

At 202, the setup module is shown. According to various embodiments, the setup module may facilitate the registration process for new users of the proposal system. The new users may be individuals, companies, or individuals working on behalf of companies. The new users may be creating RFPs, responding with proposals, or both.

According to various embodiments, the setup module 202 may also facilitate the login process for users who already have accounts. In order to log in to the proposal system 200, a user may need to provide identification information. The specific identification required may be strategically determined based on factors such as the degree of security desired, the capabilities of the client device from which the user is logging in, and the degree of convenience for the user. The type of information that may be requested from the user may include, but is not limited to: a user name, a password, a pass phrase, a personal identification number (PIN), a cryptographic certificate, or biometric information such as a fingerprint.

In some embodiments, the setup module may facilitate the registration process for new users by allowing users to log in through a third party account. For instance, a user may log in to a third party system such as LinkedIn, Facebook, or Gmail. Then, the third party service may transmit identification information for the user directly to the proposal system, for instance at the user's request. The transmitted identification information may be used to identify a previously created user account or may be used to register a new account within the proposal system. In particular embodiments, a user account within the proposal system and a user account within a third party system such as LinkedIn may be linked so that proposal-related actions may be integrated across the different systems.

According to various embodiments, user accounts may provide various features to users of the proposal system. For example, a user account may be associated with a profile that includes the user's email address and biographic data. A user account may be associated with a notification log that identifies notification messages by or to the user such as emails, Twitter messages (tweets), text messages, and messages sent via the proposal system. A user account may allow the display of a user interface for displaying activity metrics such as a number of proposals created, a number of responses created, a number of views, and a number of jobs trending. A user account may be associated with a number of social media handles, such as Facebook, Twitter, and Linkedln accounts. In particular embodiments, associating the accounts in this way may allow the user to publish proposals, requests for proposals, activity logs, and other status updates to the activity feeds of any one of the user's social networks, such as Linkedln, Facebook, or Twitter. A user account may be associated with one or more groups of users or organization accounts.

At 204, an RFP generation module is shown. According to various embodiments, the RFP generation module may facilitate the creation, editing, and review of requests for proposals. Each request for proposal may be any request to receive proposed solutions to a problem facing an individual, company, or other entity. For example, an RFP may be a request to receive proposals for fulfilling an employment opportunity. As another example, an RFP may be a request to receive proposals for a service contract for a company. Using the RFP generation module 204, a user may create a new RFP, edit or view an existing RFP, or provide comments or otherwise review an RFP.

According to various embodiments, the RFP generation module 204 may include various components. For example, the RFP generation module may include a user interface component configured to receive information such as content to include in an RFP, formatting options for formatting an RFP, access policy options specifying access information such as who may view or edit an RFP, and other such information. As another example, the RFP generation module 204 may include a data management component for storing the data that makes up an RFP. As yet another example the RFP generation module 204 may include an RFP generation assistance component operable to help users create an RFP in a standardized, easily readable format. For instance, the RFP generation assistance component may analyze user input to help the user create an RFP with clear, readable prose constructed using well-understood terms and phrases. Also, the RFP generation assistance component may analyze the formatting of the RFP to help the user create a proposal that follows a standardized ordering or fits within a size or length constraint.

According to various embodiments, the RFP generation system may provide a user interface for accessing various types of features. For example, a user dashboard may list RFPs created and published by the user. Each RFP may be associated with information such as a description, a number of views, and a number of responses. In particular embodiments, the information presented in the user dashboard may be selected based on various types of user characteristics, such as a user's identity, access level, or organizational role.

According to various embodiments, an RFP upload interface may allow the uploading of an RFP or other content in a PDF or other document format. In particular embodiments, an RFP field generator may populate user information fields with biographical information or other data collected from uploaded documents in a PDF or other document format. For instance, the proposal system may scan or process the document in order to retrieve various types of information.

According to various embodiments, a proposal replies log may provide a list for displaying and reviewing proposals submitted in response to an RFP. Users may comment on each proposal publicly, privately, or semi-privately. A log may provide an interface to request, enter, and view RFP or proposal comments, interview feedback, proposal scores, and other types of information. A log may be presented as part of the user interface in the form of a dashboard displaying statistics concerning the RFP.

According to various embodiments, an RFP generation system may include one or more RFP tracking components. RFP tracking may include one or more user interfaces for displaying and reviewing different stages of the proposal generation, application, and review process. For instance, RFP tracking may include a user interface to view workflow status associated with an RFP. For example, a workflow status may indicate timing information such as a creation date, a period of time the RFP has been open, or a period of time remaining before the RFP is closed. As another example, a workflow status may indicate approval information such as whether an RFP has been approved or rejected, is pending review, or has been flagged as requiring revisions. As yet another example, a workflow status may indicate budgetary information such as whether the RFP has been budgeted, what budget has been allocated for the RFP, and in what time period the budgetary approval applies.

A proposal creator may include an interface such as one or more forms or wizards to help the user create, edit, review, and publish an RFP. An archiving interface may provide the ability to archive RFPs, proposals, and other documents. An interview manager may provide an interface to manage interviews, comments, proposal scores, and other such information. An interview invitation interface may provide the ability for a user viewing a proposal to send an invitation to the proposal creator or another individual to participate in an interview regarding the proposal. A proposal match interface may allow a user to select and display proposals matching criteria such as content criteria and scoring criteria.

At 206, a proposal review module is shown. According to various embodiments, the proposal review module may facilitate the review of proposals and/or RFPs. Reviewing a proposal or RFP may include viewing the proposal or RFP, providing comments regarding the proposal or RFP, or providing additional information for including with the proposal or RFP. In some instances, access to a proposal or RFP may be limited by an access policy, which may specify users or organizations who may take various actions related to a proposal or RFP.

In one example, a user may be a member of a company responsible for hiring a new employee. The user may then create a request for proposals for prospective applicants to describe how they would perform in the role of the new employee. In order to ensure that the RFP accurately describes the challenges that the company faces that led to the need to hire a new employee, the RFP may be reviewed by other individuals, such as the user's supervisor or a human resources manager at the company. These individuals may provide comments, suggest additional information for including in the RFP, or edit the RFP directly.

According to various embodiments, the proposal review module may facilitate the review of proposals provided in response to an RFP. For example, a prospective employee may create a proposal to fill an employment role at a company. Then, the prospective employee's friends or colleagues may be invited to critique the proposal before the prospective employee submits it. As another example, the author of an RFP may review proposals created in response to the RFP. When the author identifies suitable proposals, the author could initiate communications with the proposer or refer the proposal for further processing, such as an interview for a job candidate.

At 210, a proposal generation module is shown. According to various embodiments, the proposal generation module may facilitate the generation of proposals in response to an RFP created via the RFP generation module 204. The proposal generation module may allow a user to create a new proposal, edit an existing proposal, review or comment on a proposal, or submit a proposal to the creator of an RFP. As discussed with respect to the RFP generation module 204, the proposal generation module 210 may have various components, such as a user interface component, a data management component, or a proposal generation assistance component.

In some embodiments, the proposal generation module may be associated with a proposal tracking system configured to present various types of information related to a generated proposal. For example, the proposal tracking system may present information such as whether a proposal has been accepted or rejected, has been flagged as needing revisions, or is pending review. As another example, the proposal tracking system may indicate status information associated with a job-seeking candidate such as “rejected,” “hired,” “first phone screen”, or “first onsite interview,” or “in need of additional documentation or work samples.”

At 212, a proposal management module is shown. According to various embodiments, the proposal management module may facilitate the processing of proposals created via the proposal generation module 210. Processing may involve operations related to sorting, selecting, evaluating, and/or commenting on proposals.

For example, an RFP for an employment opportunity at a company may result in hundreds or thousands of proposals. In this case, an automated process associated with the management module 212 may be used to identify the most promising proposals. Then, those proposals may be further ranked or sorted by users, such as hiring managers at the company who access the proposals via the management module 212, to select a limited number of candidates for interviewing. Finally, the candidates selected for interviewing may be provided with a standardized interview process involving the management module 212 to reduce bias in the hiring process and to help identify the best candidate.

As another example, an RFP for a service contract may also generate many different proposals. These proposals may include a variety of information, such as proposed service contract terms. The management module 212 may be used to aggregate, sort, and analyze this information so that the proposed service contracts may be more easily compared. Next, the management module 212 may be used to identify proposals that meet designated criteria. Then, proposals that meet the designated criteria may be reviewed by individuals, who may work together to select a proposal for adoption.

At 208, the administration module is shown. According to various embodiments, the administration module may facilitate operations, which may include, but are not limited to: reporting, configuration, data analysis, and the determination of statistics or trends related to data accessible via the system. For example, the administration module may be used to create reports on how many RFPs or proposals have been created, which organizations are associated with the creation of RFPs or responses to RFPs, and who should be billed for services provided via the proposal system. As another example, the administration module may be used to configure the proposal system, such as establishing parameter values for logging into the system, registering new user accounts, creating RFPs, creating proposals, reviewing proposals, and managing proposals. As yet another example, the administration module may be used to analyze data accessible via the proposal system. For instance, the administration module may be used to identify trends in hiring by companies, statistics describing the types of jobs being created, or analysis of the types of problems facing companies.

According to various embodiments, the administration module may facilitate reporting and data analysis specific to an RFP or users associated with an RFP or open job position. For instance, a report may be generated regarding the demographic characteristics of applicants responding to a particular job posting. In some cases, companies may need to report on demographic data voluntarily submitted by applicants such as information regarding gender, race, veteran status, and disability status.

In some embodiments, a report may be generated regarding the activity log of users in the RFP process in order to track data such as time-to-hire, number of interviews scheduled, number of applicants, number of positions open by hiring manager, number of positions budgeted per quarter, and remaining open headcount. For example, the proposal system may track (e.g., for performance monitoring purposes) the activity log of recruiters or hiring managers. As another example, the proposal system may track the number of open positions per financial quarter, for instance for financial planning and forecasting purposes.

At 214, the affiliate program module is shown. According to various embodiments, the affiliate program module may be used to allow third party software or services to interact with the proposal system. For example, a company may wish to generate or receive RFPs and/or proposals in a specialized format or with specialized branding. In this case, an affiliate program or service may be employed to facilitate the production of the RFPs and/or proposals. As another example, a third party system may be used to distribute or promote an RFP, such as on an external social network.

According to various embodiments, the affiliate program module 214 may communicate with the rest of the system in various ways. In particular embodiments, the affiliate program module 214 may include a communication interface or API. In this case, the third party software or services may be located on remote systems and communicate with the proposal system via a network. Alternately, some or all of the third party software or services may be located on computing devices associated with the proposal system 200. In this case, the affiliate program module 214 may include one or more computing devices, such as application servers, under the control of the entity providing the proposal system.

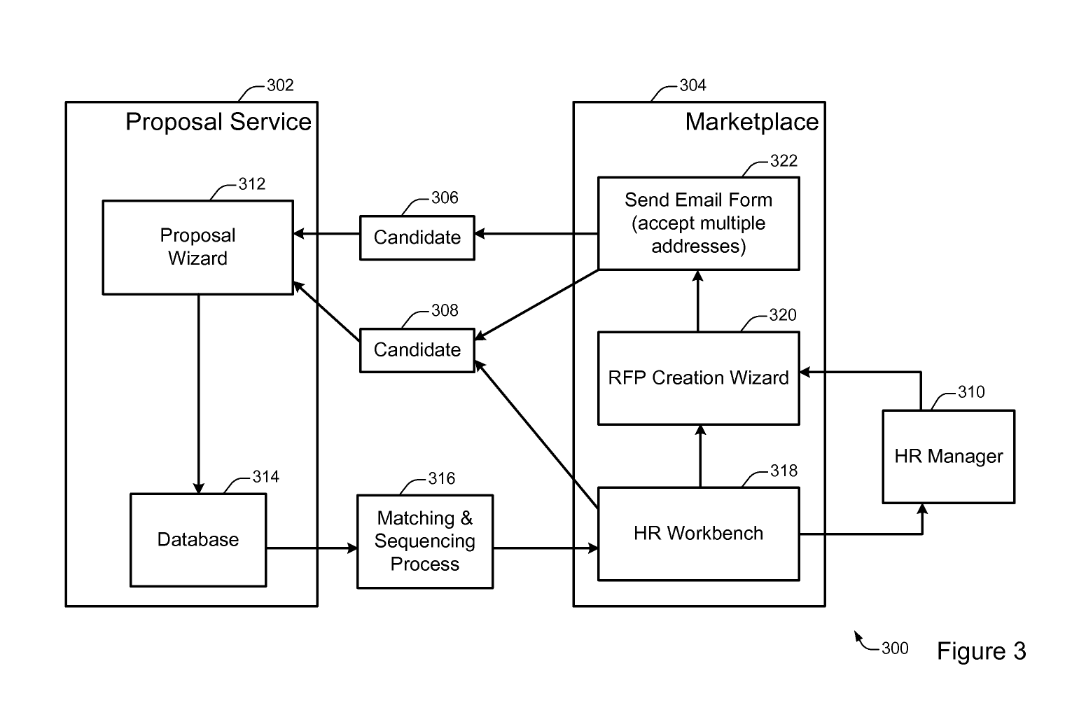

FIG. 3 shows a system 300 that may be used in accordance with techniques and mechanisms described herein. According to various embodiments, the system 300 may be used to create and respond to RFPs in the employment context. That is, the system 300 may facilitate the creation of requests for and responses to proposals to fulfill an employment need for a company.

The system 300 includes an applicant service provider (also referred to herein as a proposal service) 302 and a marketplace 304. The applicant service provider 302 includes modules operable to provide services to job applicants, such as a proposal creation wizard 312 and a storage system 314 such as a database. The marketplace 304 includes modules operable to provide services to companies, such as a human resources workbench module 318, an RFP creation wizard module 320, and a communication module 322. A proposal analysis module 316 may facilitate the transmission of information between the applicant service provider 302 and the marketplace 304. Various users, such as the job candidates 306 and 308 and the human resources manager 310 may interact with the system 300.

According to various embodiments, the marketplace 304 may allow users such as HR managers to create RFPs, to send RFPs to users, and to review proposals generated in response to RFPs. At 310, a human resources manager is shown interacting with the marketplace 304. The human resources manager may create an RFP via the RFP creation wizard 320. The RFP creation wizard 320 may be substantially similar to the RFP generation module 204 discussed with respect to FIG. 2.

According to various embodiments, when an RFP is created via the RFP creation wizard 320, one or more users may be invited to respond to the RFP via the communications module 322. The communications module 322 may facilitate the transmission of the RFP via various communications mediums. For instance, an invitation to respond to an RFP may be transmitted via email, instant message, text message, or communication via a social network such as Linkedln, Twitter, or Facebook. As another example, an invitation to respond to an RFP or job posting may be posted to the company's or hiring manager's associated social network activity feed such as, but not limited to, a Linkedln page, a Facebook page, or a Twitter account.

In particular embodiments, a user such as the human resources manager 310 may identify one or more recipients of the RFP via a list or other selection mechanism. Alternately, or additionally, the communications module 322 may assist the user in identifying recipients. For example, the communications module 322 may help the human resources manager 310 identify users of the proposal system who may be well-suited to submit a proposal in response to the RFP. As another example, the communications module 322 may identify recipients who have been sent similar proposals in the past or who have otherwise been previously designated for receiving such RFPs.

In the example shown in FIG. 3, the HR manager provides a list of e-mails to the communications module 322. Then, the communications module sends a message via e-mail to the job seekers 306 and 308. The message invites both candidates to submit a proposal in response to the RFP. The candidates 306 and 308 may create and submit such a proposal via the applicant service provider 302.

According to various embodiments, the applicant service provider may provide a number of business functions with accompanying user interfaces for job applicants to perform various operations. For example, the applicant service provider may provide a user dashboard that lists proposals created and submitted along with information such as a description of each proposal and a number of user views of each proposal. As another example, the applicant service provider may provide a proposal creator, which may include an interface containing one or more forms or guides to help the user create, edit, review, and publish a proposal. As yet another example, the service provider may provide a proposal replies log, which may allow users to list and review submitted proposals as well as to privately and/or publically comment on each proposal. As still another example, the service provider may provide an RFP browser that allows users to search, browse, and filter RFPs to identify open RFPs to which to respond.

According to various embodiments, the applicant service provider 302 is operable to provide various services to job seekers, such as the candidates 306 and 308. For example, a user may be able to view the number of recruiters who have viewed the applicant's proposals, a list of open RFPs in response to which the user is creating proposals, a list of comments that have been provided regarding the user's proposals, suggested edits to the user's proposals, and other such information. As another example, a user may be able to see a list of popular proposals or new features.

According to various embodiments, the proposal creation wizard 312 may be used to help create an appropriate response to the RFP. For example, the proposal creation wizard 312 may assist users in creating a proposal that includes content responsive to the RFP. As another example, the proposal creation wizard 312 may assist users in creating a proposal in accordance with a standardized format, such as content arranged in a particular order and/or content limited to a single page. The particular format and content associated with the proposal may be strategically determined based on factors such as the industry for which the proposal is created, the company to which the candidates are applying, the RFP to which the candidates are responding, and the type of information that is intended to be included in the proposal. The proposal creation wizard 312 may be in at least some respects substantially similar to the proposal generation module 210 discussed with respect to FIG. 2.

According to various embodiments, information received via the proposal wizard 312 may be stored in the storage module 314. The storage module 314 may include one or more databases, such as an Oracle database or a SQL database. The storage module may include various types of databases, such as a flat file database, a relational database, a cloud database, an active database, a distributed database, or any other type of database.

According to various embodiments, the information stored via the storage module 314 may include various types of information. For example, the storage module 314 may include raw data received via the proposal wizard 312. As another example, the storage module 314 may include completed proposals generated via the proposal wizard 312. As yet another example, the storage module 314 may include biographic information regarding the users who create proposals via the proposal wizard 312. The biographic information may include information such as names, ages, email addresses, sexes, mailing addresses, employment histories, information of the type normally included in resumes, or any other information.

According to various embodiments, after proposals are created, they may be analyzed via the proposal analysis module 316. The proposal analysis module 316 may perform various operations such as matching and sequencing the proposals. For example, the proposal analysis module 316 may identify RFPs in response to which a proposal may be submitted. As another example, the proposal analysis module 316 may evaluate or rank proposals to identify the best proposals submitted in response to an RFP. As yet another example, the proposal analysis module may annotate or otherwise comment on proposals.

According to various embodiments, the annotations, comments, rankings, evaluations, and/or analysis may be provided to the user who created the proposal, the company that receives the proposal, or any other user. In this way, users may receive feedback on their proposals, which may allow them to improve their proposals or identify other potential recipients of their proposals. Alternately, or additionally, recipients of the proposals may more easily identify the best proposals for adoption or for further sorting.

According to various embodiments, analyzed or processed proposals may be transmitted to companies for further evaluation. For example, proposals may be transmitted to the human resources workbench module 318. There human resources workbench may allow the proposals to be accessed or evaluated by users such as the human resources manager 310, other users within the company that generated the RFP, or users associated with third party entities such as companies who evaluate proposals or assist in the hiring process. For instance, the human resources manager 310 may review the proposals submitted to the human resources workbench module 318 and select proposals for further analysis or processing. In the example shown in FIG. 3, the human resources manager 310 selects the proposal created by the candidate 308. Then, the candidate 308 is sent a message containing an invitation to interview with the company. The operations performed via the human resources workbench module 318 may be at least in part substantially similar to the operations performed via the management module 212 discussed with respect to FIG. 2.

According to some embodiments, the evaluation of proposals may involve identifying one or more evaluators at a company responsible for evaluating the received proposal. Identifying an evaluator may involve designating an individual, a team, a computer program, or an organizational role responsible for reading and evaluating the proposal. The proposal system may facilitate the identification of an evaluator by name, email address, employee ID, department code, or any other designator. In particular embodiments, evaluators may be identified automatically, manually, or some combination thereof When an evaluator is identified, the proposal system may facilitate notifying the evaluator, for instance transmitting a message requesting that the evaluator evaluate the proposal.

According to various embodiments, the human resources workbench 318 may provide a user interface for viewing various types of information. for example, a user such as the human resources manager 310 may view information such as the number of candidates who have responded to an RFP, a number of days remaining for responding to an RFP or proposal, a list of new proposals submitted in response to RFPs, a list of comments to RFPs, and a number of direct messages transmitted via the proposal system. In particular embodiments, messages may be transmitted between any users or organizations registered with the proposal system.

According to various embodiments, the human resources workbench module 318 may facilitate further evaluation of the candidates who created proposals via the proposal wizard 312. For instance, the human resources manager 310 may select a number of the candidates for interviewing. Then, the human resources manager 310 may select or create a number of interview questions for posing to the selected candidates. The candidates may then be interviewed in various ways. For example, the candidates may receive the interview questions via email and provide responses to the human resources workbench module 318. As another example, the candidates may be interviewed by the human resources manager 310. As yet another example, the candidates may be interviewed by another entity such as an individual associated with a third party interview service or with the applicant service provider 302. The candidates responses may be stored, for instance via the human resources workbench module 318 and/or the storage module 314. In this way, the human resources manager 310 may analyze and evaluate the responses to select the best candidate.

FIG. 4 illustrates one example of a method 400 for evaluating a proposal based on machine evaluation techniques in accordance with techniques and mechanisms described herein. According to various embodiments, the method 400 may be used to evaluate one or more proposals based on criteria such as the presence and usage of keywords in the proposal. In particular embodiments, proposals may be compared with previously analyzed proposals that proved to be successful. By analyzing proposals based on a machine evaluation, a group of proposals may be quickly processed and sorted to select the best proposals for further analysis.

At 402, a request to evaluate a proposal based on machine evaluation is received. According to various embodiments, the request may be generated as part of an overall evaluation process of the proposal. In particular embodiments, the request may identify any number of proposals to evaluate via machine evaluation. By evaluating many proposals with a similar process, the proposals may be more objectively compared with each other.

At 404, a keyword is selected to search for in the proposal. According to various embodiments, keywords may be identified in various ways. For example, a user such as the creator of an RFP or a hiring manager may identify one or more keywords that the user deems important in evaluating proposals. As another example, the proposal system may suggest or identify keywords that are commonly used or that have been often used in successful, previously analyzed proposals.

At 406, a number of matches for the keyword are identified. In particular embodiments, the number of matches for the keyword may be determined by string searching techniques. For instance, the proposal content may be compared with the keyword string with a string comparison library in a computer programming language.

At 408, a context for each keyword match is determined In particular embodiments, the context identifies a setting or circumstance surrounding the usage of the keyword. For instance, some keywords may be more relevant when they appear in one section of a proposal than in another section. In a proposal for an employment opportunity, for example, a keyword that appears in a proposed solution section of a proposal may be considered more relevant than a keyword that appears in a basic information or main content section of the proposal.

At 410, a proposal score value for the keyword is determined. According to various embodiments, the proposal score may be determined based on various criteria or factors. For example, the usage of keywords in successful, previously analyzed proposals may be compared with the usage of keywords in the proposal currently under analysis. As another example, a user may designate some sections of a proposal as being more relevant than other sections. As yet another example, some keywords may be deemed more relevant when used in combination with one another. The proposal score value may indicate a relevance or importance of the keyword as used in the proposal, reflecting an impact of the keyword on the overall quality or match of the proposal.

At 412, a determination is made as to whether to select additional keywords for analysis. In particular embodiments, each proposal in a group may be analyzed based on a designated list of keywords. In this way, the analysis procedure for each proposal may be the same. Alternately, a proposal may be analyzed based on keywords until a designated criterion is met. For example, a proposal may be evaluated until the score converges to a value. As another example, a proposal may be analyzed until a designated number of keywords are identified within the proposal. For instance, keywords may be analyzed in order of perceived importance until a threshold number is reached.

At 414, the proposal score values for the keywords are aggregated to create a machine-based proposal score. According to various embodiments, the proposal score values may be aggregated in various ways. For instance, keyword scores may be averaged, summed, or weighted based on significance. In particular embodiments, a statistic such as variance or standard deviation may be determined to better explain an aggregated score value. The score may indicate a quality or relevance

At 416, the machine-based proposal score is stored. According to various embodiments, various types of information may be stored. For instance, the stored value or values may include any or all of the raw data created during the evaluation process. Alternately, or additionally, the stored value or values may include the processed data based on the aggregate value or values determined in operation 414. In particular embodiments, the data may be stored in a database system, such as the database systems discussed in relation to FIGS. 2-3 and 7-10.

FIG. 5 illustrates one example of a method 500 for evaluating a proposal based on human evaluation techniques in accordance with techniques and mechanisms described herein. In particular embodiments, the method 500 may be used to facilitate the review of many proposals by one or more human evaluators. By causing proposals to be evaluated based on designated criteria and then aggregating the resulting scores, the evaluation process may be made more efficient and objective.

At 502, a request to evaluate proposals based on interviews is received. In many respects, the operation 502 may be substantially similar to the operation 402 discussed with respect to FIG. 4. In some instances, the request to evaluate a proposal may designate any number of proposals for evaluation. In this way, many different proposals may be subjected to a similar evaluation process, thus facilitating a more accurate comparison of the different proposals.

In particular embodiments, the request to evaluate a proposal based on human evaluation may be generated for proposals that meet some threshold criterion or value. For instance, evaluation by human evaluators may be limited to those proposals that meet a designated score based on machine evaluation. In this way, the comparatively larger amount of resources expended when evaluating a proposal by a human rather than by a computer program may be conserved. Further, the machine-based evaluation may be treated as a sorting mechanism, allowing a selection of the best proposals for analysis by humans. In this way, the proposal evaluation system may quickly, efficiently, and objectively process a large number of proposals.

At 504, a number of sections of the proposal are identified for analysis. According to various embodiments, the sections may be identified in various ways. For instance, the sections may be selected or entered into a user interface, which may be similar to the user interface for creating an RFP. In particular embodiments, the sections may be identified at least in part based on the contents of the proposal as specified in an associated RFP. For example, the RFP may have sections such as specific actions that the proposal is requesting and specific questions asked in the RFP. Alternately, or additionally, the sections may be identified at least in part based on other criteria, such as whether the proposal is well-organized and grammatically correct. Thus, although the criteria for evaluating the proposals by humans are referred to herein as sections, these sections need not correspond to actual sections of the proposal and may correspond more generally to features or qualities exhibited by the proposals.

At 506, an evaluator is selected for evaluating the proposal. According to various embodiments, the selected evaluator may be any of various individuals. For example, the evaluator may be a member of a company that created an RFP in response to which the proposal was submitted. In this case, the evaluator may be the author of the RFP, a hiring manager, a human resources manager, a team manager, or any other individual. As another example, the evaluator may be a member of a third party service, such as a third party employment services provider.

At 508, the proposal is transmitted to the evaluator for evaluation. The proposal may be sent to the evaluator by e-mail or other message. Alternately, or additionally, the evaluator may access a user interface for evaluating the proposal via the proposal system. For instance, the evaluator may evaluate the proposal via the human resources workbench module 318 discussed with respect to FIG. 3.

At 510, a proposal score value is received for each of the identified sections. According to various embodiments, the proposal score value may be entered by the evaluator. The proposal score value may reflect the evaluator's ranking or estimate of the quality of each of the sections. Various types of score ranges or scales may be used for the proposal score value. For instance, each of the sections may be ranked on a scale of one through five. Alternately, or additionally, one or more of the sections may be ranked on a more qualitative scale. In particular embodiments, the technique for evaluating a particular section may be strategically determined based on factors such as the type of section being evaluated and whether the factor is susceptible to qualitative and/or quantitative evaluation.

At 512, a determination is made as to whether to select additional evaluators for analysis. According to various embodiments, various criteria may be used to determine whether to select an additional evaluator. For example, each proposal in a group may be reviewed by the same or similar group of evaluators in order to make the review process more objective. When the group of evaluators for a group of proposals is the same, then the evaluations can be more readily compared. As another example, each proposal in a group may be reviewed until a consensus appears. For instance, if the evaluations of a proposal are divergent, then additional evaluators may be selected to resolve the disagreement in evaluations. If instead the previous evaluators largely agree regarding the evaluation of the proposal, then additional evaluators may not be selected.

At 514, the proposal score values are aggregated to create a human-based proposal score. According to various embodiments, the proposal score values may be aggregated in various ways. For example, the proposal score values from each evaluator may be aggregated to create an aggregated score for each evaluator. As another example, the proposal score values for each of the sections may be aggregated to create an aggregate score value for each of the sections. As yet another example, all of the score values may be aggregated to create an overall human-based score value for the proposal.

According to various embodiments, the proposal score values may be aggregated in various ways. For instance, the proposal score values may be added together, averaged, or otherwise combined. In particular embodiments, a statistic such as a standard deviation or variance may be calculated to facilitate a better understanding of the aggregated value.

At 516, the human-based proposal score is stored. In many respects, the operation 516 may be substantially similar to the operation 416 discussed with respect to FIG. 4. According to various embodiments, various types of information may be stored. For instance, each score provided by each of the human evaluators may be stored. Additionally, or alternately, an aggregate score may be stored for each proposal and each evaluator. In particular embodiments, each proposal may be assigned an aggregate score that reflects the scores of all of the human evaluators of that proposal, as discussed with respect to operation 514.

FIG. 6 illustrates one example of a method 600 for evaluating a proposal based on interview evaluation techniques in accordance with techniques and mechanisms described herein. According to various embodiments, the method 600 may be used to support an objective, organized interview process in which each proposal is evaluated based on the same set of criteria. By evaluating a set of proposals via the same interview process, the scores assigned to the proposals may be compared in order to establish an objective ranking or comparison of the proposals.

At 602, a request to evaluate proposals based on interviews is received. According to various embodiments, the request may be received as part of a larger evaluation process for proposals, as discussed with respect to FIG. 1. For instance, the request may identify any number of proposals for evaluation via interview.

In particular embodiments, the request received at 602 may be generated based on scores for other types of evaluations. For instance, when a proposal receives a sufficiently high score from a machine review and/or human reviewers, the proposal may be designated for further analysis via an interview. By first reviewing proposals quickly using computer programs or rapid human review, the comparatively larger amount of resources expended in the interview process may be reduced.

At 604, a number of interview factors are identified for evaluation. According to various embodiments, interview factors may be identified in a standardized way, such as by accessing a user interface in the proposal system devoted to establishing interview factors for an RFP or a set of proposals.

In particular embodiments, the interview factors identified may be similar to the evaluative criteria discussed with respect to machine-based and human-based evaluation. That is, interview factors may include answers to specific questions, a discussion of main content, specific proposals for actions, or other criteria.

According to various embodiments, the interview factors identified may include interview-specific factors that may not be applicable to machine-based or human-based review of proposals alone. For instance, the interview factors may include factors related to communication skills, personality traits, the ability to respond quickly and intelligently to questions, apparent level of comfort or confidence exhibited during the interview process, and other such traits.

According to various embodiments, interview factors may be identified by various users of the proposal system. For example, interview factors may be identified by an author or editor of an RFP in response to which the proposals were submitted. As another example, interview factors may be identified by other users of the system, such as a trained interviewer or a human resources manager.

According to various embodiments, interview factors may be suggested by the proposal system. Interview factors may be suggested based on information such as the presence of interview factors in past interviews, the performance of interview factors in previous interviews, interview factors that tend to elicit useful information from interviewees, and interview factors that tend to elicit standardized or easily reviewable responses from interviewees.

At 606, a proposal may be selected for analysis. According to various embodiments, proposals may be selected in various ways. For example, proposals may be selected in an order determined by the scores generated via machine and/or human evaluation. In this way, the best proposals may be evaluated first, thus potentially reducing the resources expended conducting interviews. As another example, all proposals that meet some threshold may be selected for interviewing, in which case any ordering may be used.

At 608, an interview directed to the identified interview factors is conducted. According to various embodiments, the interview may be conducted via any of various mediums. For instance, the interview may be conducted by telephone, by e-mail, or in person. The interview may be conducted by the creator of the RFP, by an individual such as a human resources manager, by a third party interview service, by a computer program, or by any other entity.

When the interview is conducted, the candidate is evaluated in accordance with the interview factors identified at operation 608. At 610, a proposal score value for each of the identified interview factors is received. In particular embodiments, the proposal score value is a value on a scale such as the scale of one through five. The proposal score values are received at a computing device capable of processing and storing the score values for later retrieval or further analysis.

In particular embodiments, the scores are assigned by the entity performing the interview. Alternately, or additionally, an interview may be recorded for further analysis, and the scores may be assigned by another entity reviewing the interview.

At 612, the proposal score values are stored. According to various embodiments, the proposal score values may be stored in a database system. The proposal score values may be transmitted to a user or may be reviewed through a user interface such as the human resources workbench 318 discussed with respect to FIG. 3. Then, the interview-based proposal score values may be used along with other score values to determine whether to adopt the proposal.

According to various embodiments, the interview-based proposal score values may be combined to produce an aggregated interview-based proposal score value. For instance, the scores may be averaged, added together, or otherwise combined. In particular embodiments, a standard deviation or other statistic may be calculated in order to better characterize the proposal's evaluation.

According to various embodiments, the interview-based proposal score values may be combined with other types of score values to produce an aggregated score. As discussed above, score values may be combined in various ways. Also, in some instances, summary statistics may be calculated for the aggregated score values.

At 614, a determination is made as to whether to select an additional proposal for analysis. As discussed herein, the number of proposals selected for analysis via interview may be less than the number of proposals selected for machine analysis or human review. In this way, the resources expended during the interview process may be reduced.

According to various embodiments, proposals may continue to be selected for analysis until a designated criterion is met. For example, proposals that have been assigned a designated score based on human and/or machine evaluation may be selected for interview analysis. As another example, a percentage of the highest scoring proposals may be selected for interview analysis. As yet another example, proposals may be continue to be selected for interview analysis until a designated number of proposals have been awarded a sufficiently high interview score.

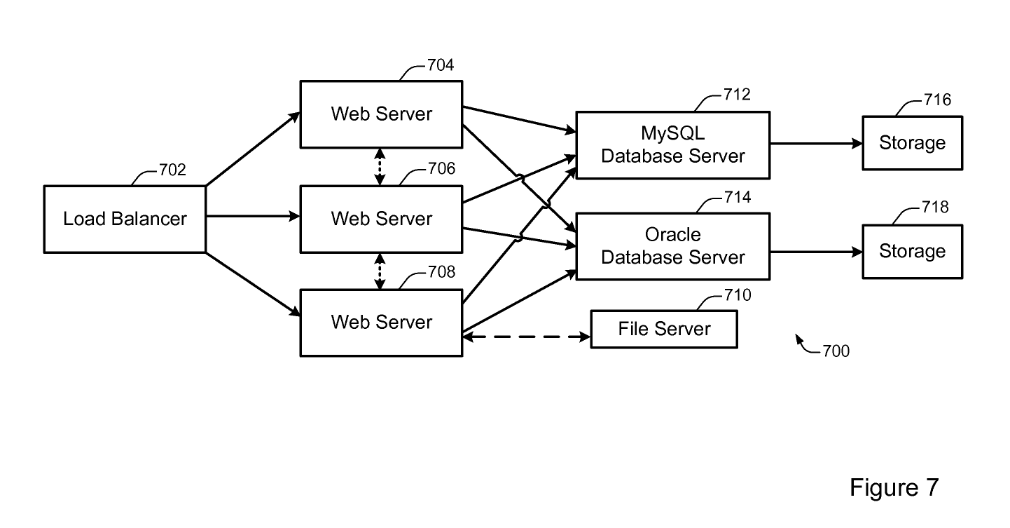

FIG. 7 shows one example of a system 700 that may be used in accordance with techniques and mechanisms described herein. The system 700 represents the conceptual architecture of at least a part of the proposal system, configured in accordance with one or more embodiments. The system 700 includes a load balancer 702, web servers 704, 706, and 708, a file server 710, a MySQL database server 712, an Oracle database server 714, and storage modules 716 and 718.

According to various embodiments, the system 700 may be operable to provide services via a network such as the Internet. For instance, the system 700 may be operable to provide the services discussed with respect to the system 200 shown in FIG. 2 and/or the system 300 shown in FIG. 3. The system 700 may be operable to facilitate operations such as registering users, logging users onto the system, generating RFPs or proposals, reviewing RFPs or proposals, analyzing or processing RFPs or proposals, and/or managing or administering the system.

According to various embodiments, the system 700 may be hosted on a cloud-computing architecture. Cloud-computing providers allow the rapid deployment and hosting of a set of web applications. Further, applications hosted in a cloud environment are readily scalable as the applications and usage grows. Employing servers configured for cloud computing may facilitate a just-in-time infrastructure in which servers and instances may be self-provisioned based on factors such as the growth and demand of the applications.

According to various embodiments, the load balancer 702 may be operable to distribute the communications and/or computing load associated with the system among several web servers. As part of this process, the load balancer may receive requests via a network such as the Internet. Then, the load balancer may select a web server for handling the request. The load balancer may select a web server based on an amount of traffic being handled by the different web servers, a number of previous requests sent to a web server, a status condition reported by a web server, or any other criteria. In particular embodiments, after the load balancer directs a request to a particular web server, the web server may establish a communication session with the requesting machine. Then, further communications may be carried out directly between the requesting machine and the web server, bypassing the load balancer 702.

The system 700 includes the web servers 704-708. According to various embodiments, each web server may be a combination of software and hardware operable to receive requests via a network and transmit responses to at least some of those requests. For instance, a web server may receive a request to display a web page, such as a web page displaying a user interface for generating an RFP or a proposal. In order to respond to the requests, the web servers may communicate with other computing devices on the network, such as application servers and database servers. The web servers may employ proprietary and/or non-proprietary web server software, such as web server software available from Microsoft or from the Apache Software Foundation. Although the system 700 shown in FIG. 7 includes three web servers, various types and numbers of web servers may be employed. The types and numbers of web servers used may be strategically determined based on factors such as the amount and type of traffic handled by the web servers.

According to various embodiments, the file server 710 may be operable to store files that may be transmitted by the web servers in response to requests received via a network. For example, the file server 710 may store relatively static web pages that may be provided to client machines relatively unchanged. These static web pages may be cached for faster delivery to users. As another example, the file server 710 may store relatively dynamic web pages that may be modified based on dynamic information, such as information retrieved from the database servers 712 and 714.

According to various embodiments, the database servers 712 and 714 may handle requests to retrieve information stored in a database or to store information in a database. In particular embodiments, different types of database servers may be used for different types of tasks. For example, the MySQL database server 712 may be used for storing dynamic data related to the user interface. As another example, the Oracle database server 714 may be used for storing business data. The types and numbers of database servers used may be strategically determined based on the type of information stored in the databases and the types of relationships between the information.

According to various embodiments, the storage modules 716 and 718 may each include one or more storage devices configured for storing data. At least some of the data stored in the storage modules may be stored in accordance with a database format associated with a database server. For instance, the storage module 716 may store information in accordance with a MySQL database format and the storage module 718 may store information in accordance with the Oracle database format.

According to various embodiments, the modules and components shown in FIG. 7 may be arranged in various ways. For example, some modules or components may be located in different physical devices that communicate via a network. As another example, some modules or components may be located in the same physical machine. As discussed herein, the system 700 is an example of a system that may be used, and systems operable to perform similar operations may include various numbers and types of modules and components.

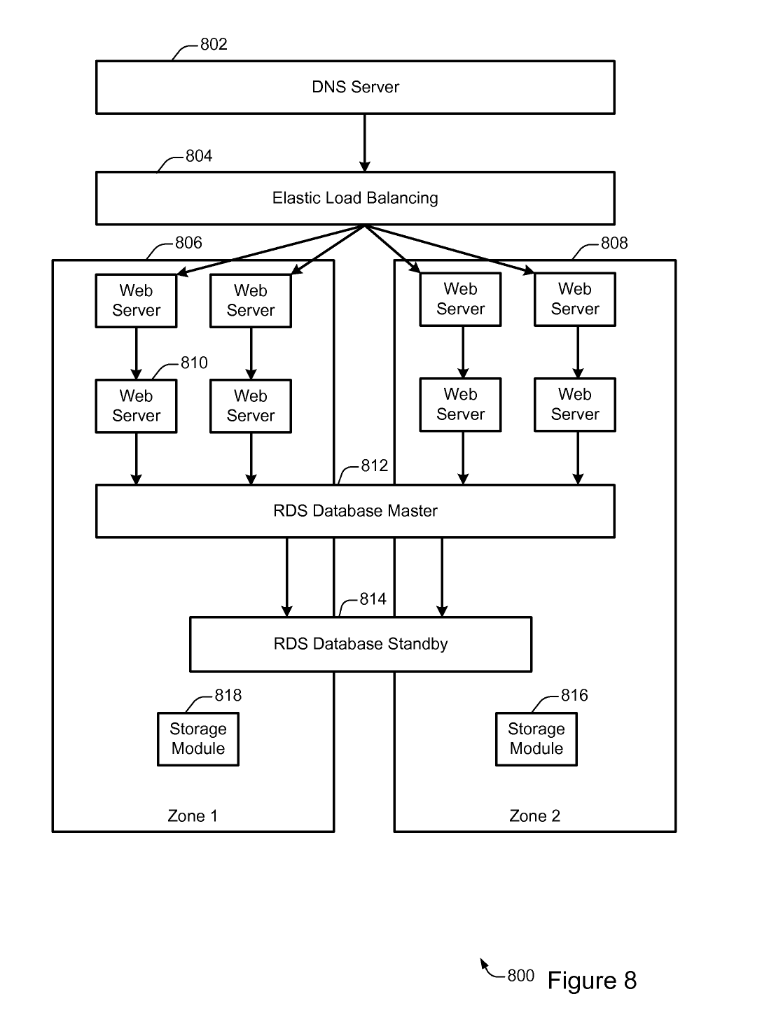

FIG. 8 shows a system 800 that may be used in accordance with techniques and mechanisms described herein. The system 800 shows a cloud-based infrastructure for providing the services related to generating RFPs and proposals. According to various embodiments, various providers of cloud-based infrastructures may be used. The system 802 includes a DNS server 802, a load balancer 804, a first group of web servers 806, a second group of web servers 808, a master database server 812, a standby database server 814, and storage modules 816 and 818.

According to various embodiments, the DNS server 802 may receive communications and identify a destination address for the communications. The load balancer 804 may select a web server for handling the traffic to help avoid or reduce network congestion. The web servers may be divided into different groups, such as groups based on geographic region, which may reduce network congestion as well as provide protection against failure at specific locations.

According to various embodiments, each web server may include a real and/or virtual server that can be configured based on various criteria, such as the computing needs of the application running on the server. Each web server may receive network communications, process the communications to prepare a response, perform any necessary communications with other servers such as application servers or database servers, and transmit the response. In some instances, some web servers may act as application servers. Application servers may serve web pages as well or may provide information to other servers for serving web pages.

According to various embodiments, the master database server 812 may organize data via a relational database, with the standby database server 814 performing backup functions. In particular embodiments, the database servers may store information in two or more types of databases. For example, MySQL databases may be used to store information such as graphical user interface (GUI) data and web analytics data, while Oracle databases may be used to store information such as business data and domain data.

According to various embodiments, the data accessed via the database servers may be stored in the storage modules 816 and 818. The storage modules 816 and 818 may provide a durable, distributed mechanism for storing host files, database files, eternal files such as PDFs and images, and any other type of files.

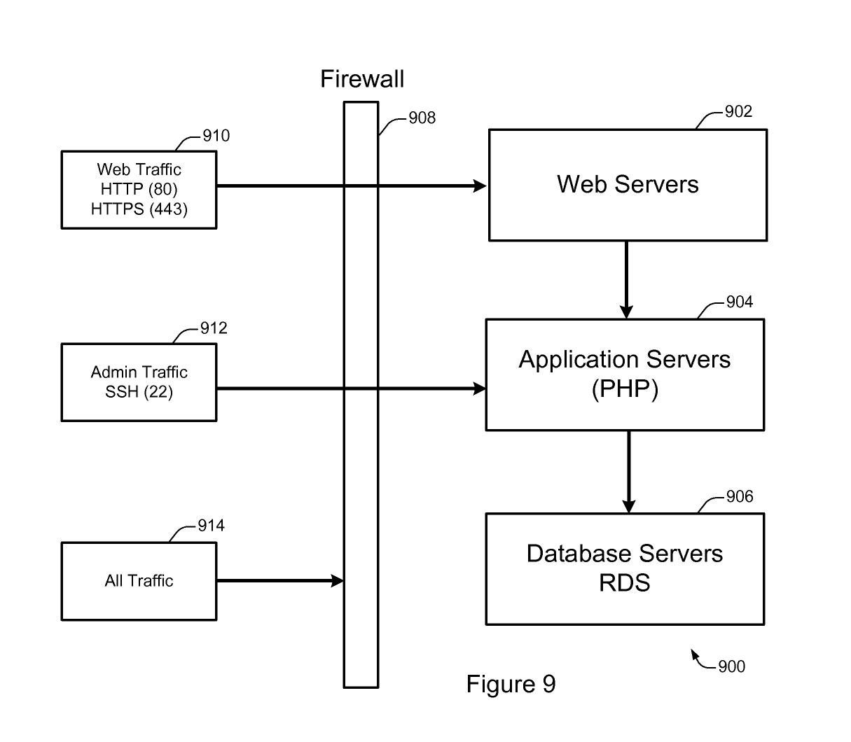

FIG. 9 shows a system 900 that may be used in accordance with techniques and mechanisms described herein. The system 900 shows the enforcement of a security protocol to protect against malicious or inadvertently dangerous network traffic. The system 900 includes one or more web servers 902, one or more application servers 904, and one or more database servers 906. Web traffic 910 and administration traffic 912 may be transmitted through a firewall 908. By routing traffic through a firewall, the servers such as web servers, application servers, and database servers may be protected.

According to various embodiments, the servers shown in FIG. 9 may be substantially similar to servers shown in other figures. For example, the web servers 902 may be substantially similar to the web servers 710 discussed with respect to FIG. 7. As another example, the database servers 906 may be substantially similar to the database servers 712 and 714. As yet another example, the application servers 904 may facilitate the type of operations discussed with respect to the systems 200 and 300 shown in FIGS. 2 and 3.

According to various embodiments, web traffic may include communications with client machines associated with users such as RFP and proposal authors. This web traffic may be transmitted via a protocol such as HTTP or HTTPS. The web traffic may be received at the web servers 902. In some instances, responses to requests transmitted via web traffic may be provided by a web server alone. For example, a request for a static web page such as a login page may in some instances be provided without accessing an application server. In some instances, providing responses to some requests may interact with an application server. For example, a request to edit an RFP based on user input may involve transmitting a message to an application server to perform the requested task. In some instances providing responses to some requests may involve transmitting a message to a database server. For example, a request to view an existing RFP may involve retrieving the RFP from a database.

According to various embodiments, administrative traffic may involve communications related to configuration, analysis, forecasting, or other administrative operations. Administrative traffic may be routed through the firewall 908 directly to the application servers 904.

According to various embodiments, the firewall 908 may include hardware and/or software. The firewall 908 may help to control incoming and/or outgoing network traffic. For example, the firewall 908 may analyze data packets and determine whether each packet should be allowed to pass through the firewall. The firewall 908 may function as a bridge between the internal network, which may be assumed to be secure and trusted, and an external network such as the internet, which is not assumed to be secure and trusted.

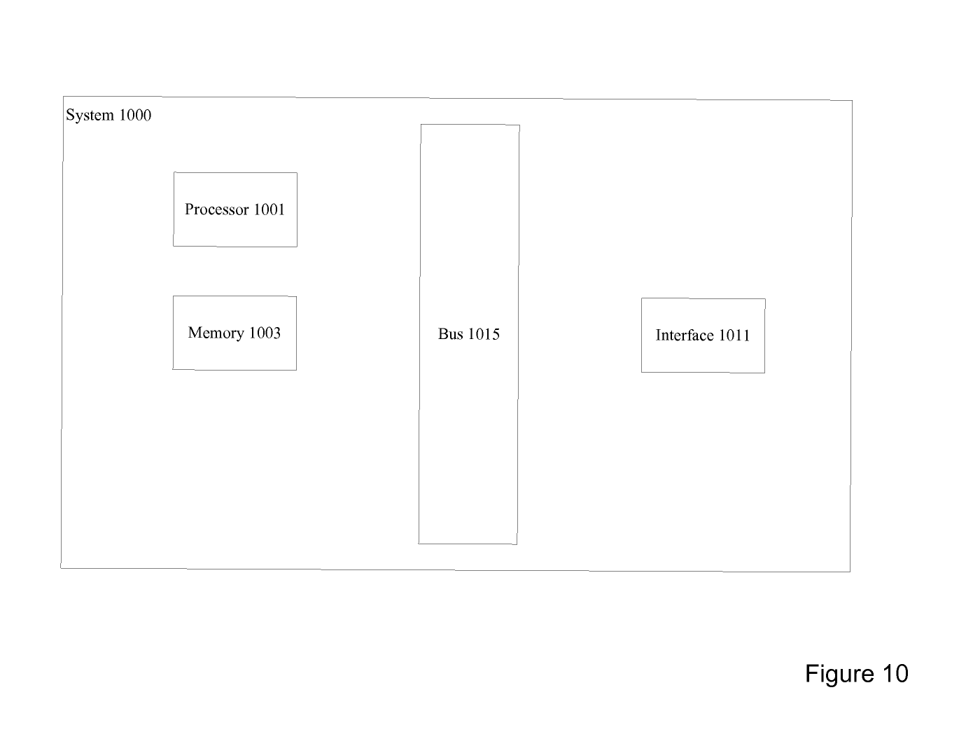

FIG. 10 illustrates one example of a server. According to particular embodiments, a system 1000 suitable for implementing particular embodiments of the present invention includes a processor 1001, a memory 1003, an interface 1011, and a bus 1015 (e.g., a PCI bus or other interconnection fabric) and operates as a streaming server. When acting under the control of appropriate software or firmware, the processor 1001 is responsible for modifying and transmitting live media data to a client. Various specially configured devices can also be used in place of a processor 1001 or in addition to processor 1001. The interface 1011 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 1000 is a server that transmits and receives communications via a network such as the Internet. In particular embodiments, the system 1000 may be configured as a database server, a web server, an application server, a file server, or any other server. The system 1000 may be in communication with client machines, such as desktop computers, laptop computers, mobile devices, smart televisions, or other servers.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices. Computer readable media encoded with the software/program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to communicate with a particular component or device and may instead include the component or device itself. A variety of configurations are possible.

1. A method comprising
processing a proposal document via a processor, the proposal document representing a proposal for business action to determine a plurality of scores for the proposal document, each of the plurality of scores evaluating the proposal document in accordance with a respective one or more criteria;
aggregating the plurality of proposal scores via the processor to create a composite score for the proposal document, the composite score representing a measure of quality associated with the proposal document; and
storing the composite score on a storage medium.

2. The method recited in claim 1,
wherein the proposal document is arranged on a single page.

3. The method recited in claim 1,
wherein the proposal document is associated with a request for proposals document describing a business need, and wherein the one or more criteria measure a responsiveness of the proposal document to the business need described in the request for proposals document.

4. The method recited in claim 1,
wherein the plurality of scores includes a first score determined by analyzing the proposal for the presence of one or more keywords via the processor, a second score determined based on first user input representing evaluation of the proposal by a human, and a third score determined based on second user input representing an interview conducted in association with the proposal.

5. The method recited in claim 1,
wherein the plurality of proposal scores includes a keyword-based proposal score determined by analyzing the proposal document for the presence of one or more keywords.

6. The method recited in claim 5, wherein determining the keyword-based proposal score comprises:
identifying a match for a designated one of the one or more keywords, the one or more criteria including an indication of the one or more keywords,
determining a context associated with the identified match, and
determining a keyword match score value based on the determined context.

7. The method recited in claim 1,
wherein the plurality of proposal scores includes a human-based proposal score determined by analyzing user input representing evaluation of the proposal document by a human.

8. The method recited in claim 7,
wherein determining the human-based proposal score comprises identifying a plurality of sections of the proposal document for analysis, the one or more criteria designating the plurality of sections, wherein the user input includes a respective section score value for each of the identified plurality of sections.

9. The method recited in claim 1,
wherein the plurality of proposal scores includes an interview-based proposal score determined by analyzing user input representing an interview of an individual in association with the proposal document.

10. The method recited in claim 9,
wherein determining the interview-based proposal score comprises identifying a plurality of interview factors for evaluation, and wherein the user input includes a respective interview factor score value for each of the identified interview factors.

11. A system comprising:
a communications interface operable to receive a proposal document representing a proposal for business action;
a processor operable to:
process the proposal document to determine a plurality of scores for the proposal document, each of the plurality of scores evaluating the proposal document in accordance with a respective one or more criteria, and
aggregate the plurality of proposal scores via the processor to create a composite score for the proposal document, the composite score representing a measure of quality associated with the proposal document; and
a storage medium operable to store the composite score.

12. The system recited in claim 11,
wherein the proposal document is associated with a request for proposals document describing a business need, and wherein the one or more criteria measure a responsiveness of the proposal document to the business need described in the request for proposals document.

13. The system recited in claim 11,
wherein the plurality of scores includes a first score determined by analyzing the proposal for the presence of one or more keywords via the processor, a second score determined based on first user input representing evaluation of the proposal by a human, and a third score determined based on second user input representing an interview conducted in association with the proposal.

14. The system recited in claim 11,
wherein the plurality of proposal scores includes a keyword-based proposal score determined by analyzing the proposal document for the presence of one or more keywords, and wherein determining the keyword-based proposal score comprises:
identifying a match for a designated one of the one or more keywords,
determining a context associated with the identified match, and
determining a keyword match score value based on the determined context.

15. The system recited in claim 11,
wherein the plurality of proposal scores includes a human-based proposal score determined by analyzing user input representing evaluation of the proposal document by a human, and wherein determining the human-based proposal score comprises identifying a plurality of sections of the proposal document for analysis, the one or more criteria designating the plurality of sections, wherein the user input includes a respective section score value for each of the identified plurality of sections.

16. The system recited in claim 11,
wherein the plurality of proposal scores includes an interview-based proposal score determined by analyzing user input representing an interview of an individual in association with the proposal document, and wherein determining the interview-based proposal score comprises identifying a plurality of interview factors for evaluation, and wherein the user input includes a respective interview factor score value for each of the identified interview factors.

17. One or more computer readable media having instructions stored thereon for performing a method, the method comprising:
processing a proposal document via a processor, the proposal document representing a proposal for business action to determine a plurality of scores for the proposal document, each of the plurality of scores evaluating the proposal document in accordance with a respective one or more criteria;
aggregating the plurality of proposal scores via the processor to create a composite score for the proposal document, the composite score representing a measure of quality associated with the proposal document; and
storing the composite score on a storage medium.

18. The one or more computer readable media recited in claim 17,
wherein the proposal document is arranged on a single page.

19. The one or more computer readable media recited in claim 17,
wherein the proposal document is associated with a request for proposals document describing a business need, and wherein the one or more criteria measure a responsiveness of the proposal document to the business need described in the request for proposals document.

20. The one or more computer readable media recited in claim 17,
wherein the plurality of scores includes a first score determined by analyzing the proposal for the presence of one or more keywords via the processor, a second score determined based on first user input representing evaluation of the proposal by a human, and a third score determined based on second user input representing an interview conducted in association with the proposal.
